(19) United States
(12) Patent Application Publication
(10) Pub. No.: US 2025/0178016 A1
(43) Pub. Date: Jun. 5, 2025

(54) COATING DEVICE AND METHOD FOR PRODUCING WEB WITH COATING FILM

(71) Applicant: Toray Industries, Inc., Chuo-ku, Tokyo (JP)

(72) Inventors: Masanao OBORI, Otsu-shi, Shiga (JP); Kiyoshi TANINO, Otsu-shi, Shiga (JP)

(73) Assignee: Toray Industries, Inc., Chuo-ku, Tokyo (JP)

(21) Appl. No.: 18/842,187

(22) PCT Filed: Feb. 7, 2023
(86) PCT No.: PCT/JP2023/004046

§ 371 Date: Aug. 28, 2024

(30) Foreign Application Priority Data
Mar. 15, 2022 (JP) 2022-039893

(51) Int. Cl. B05C 1/08; B05C 1/16

(52) U.S. Cl. CPC B05C 1/0813; B05C 1/165

(57) ABSTRACT

Provided is a coating device for coating a web that is traveling with coating liquid. The coating device includes: a coating bar extending in a web width direction; a partition disposed below an axial center of the coating bar in a vertical direction, the partition extending in the web width direction; and an upstream container and a downstream container disposed on an upstream side and a downstream side in a web conveyance direction, respectively, with the partition interposed between the upstream container and the downstream container, the upstream container and the downstream container including side plates disposed inward in the web width direction with respect to both ends of the partition on a web width direction side, the upstream container and the downstream container being configured to store the coating liquid.

### CROSS REFERENCE TO RELATED APPLICATIONS

This application is the U.S. National Phase of PCT/JP2023/004046, filed Feb. 7, 2023 which claims priority to Japanese Patent Application No. 2022-039893, filed Mar. 15, 2022, the disclosures of these applications being incorporated herein by reference in their entireties for all purposes.

### FIELD OF THE INVENTION

The present invention relates to a coating device and a method for producing a web with a coating film.

### BACKGROUND OF THE INVENTION

Conventionally, as a method for uniformly applying coating liquid to a surface of a web such as a thermoplastic resin film that is being conveyed, there is a bar coating method. This is a method in which a coating bar extending in a width direction of the web is pressed against a lower surface of the web that is traveling and rotated by a frictional force generated between the coating bar and the web or a driving force applied by a motor or the like to scrape off (measure) an excessive amount of coating liquid that has been previously supplied to the web.

However, the application of the coating liquid by the bar coating method has a problem that bubbles may be caught in the coating film when scraping off the coating liquid, resulting in streaks or defects. This is caused by entrainment of air in the coating liquid when the web is started to get wet on an upstream side of a portion to be coated due to the influence of air accompanied by the web that is traveling, entrainment of air in the coating liquid at a gas-liquid interface in the vicinity of the coating bar due to the influence of air accompanied by the coating bar that is rotating, or the like. In this regard, as disclosed in Patent Literature 1, a device configuration for preventing entrainment of air by supplying a liquid to each of an upstream side and a downstream side of a coating bar has been generally known. For example, when a web travels from the upstream side to the downstream side at a high speed, the liquid supply from the upstream side is increased, thereby preventing entrainment of air accompanied by the web that is traveling, and the coating bar rotating forward with respect to the traveling web rotates at a high speed, the liquid supply from the downstream side is increased, thereby preventing entrainment of air accompanied by the rotation of the coating bar that is rotating. In this manner, entrainment of air is prevented by adjusting the amounts of coating liquid supplied to the upstream side and the downstream side of the coating bar in accordance with the coating conditions. In addition, the coating bar is easily deflected due to its own weight or a force received from the web, because it generally has a cylindrical shape with a diameter of several tens of mm and a length of several hundreds of mm to several thousands of mm. As a method for preventing this deflection, as disclosed in Patent Literature 1, a configuration is often adopted in which a support having a V-shaped or arc-shaped cross section extending in the width direction of the coating bar is brought into contact with the coating bar from below to support the coating bar. In this configuration, the upstream side and the downstream side of the coating bar are separated by the support. By separating the upstream side and the downstream side, the coating liquid supplied from the upstream side is supplied to the upstream side of the coating bar, and the coating liquid supplied from the downstream side is supplied to the downstream side of the coating bar, so that the amounts of coating liquid to be supplied to the upstream side and the downstream side can be individually adjusted, thereby easily adjusting the amounts of coating liquid to counter the above-described entrainment of air.

The bar coating method is applied to an in-line coating method in which the bar coating method is introduced into a line for forming a film of a web to coat and dry the web during film formation, and an off-line coating method in which the bar coating method is introduced into a line including a mechanism for unwinding a web wound in a roll type and a mechanism for winding the web to coat and dry the web while being conveyed. For the in-line coating method, it has been known to coat the web before being conveyed to a tenter oven in which web end portions are gripped with clips or pins while particularly a stretchable film such as a PET film or a PP film of the web is heated to stretch the web in a web width direction. In the in-line coating method, since the end portions of the web are gripped with clips, pins, or the like, it is important not to apply coating liquid to the end portions of the web so as not to affect the gripping. Since the width of the web varies depending on the product, the coating device is required to have a mechanism capable of appropriately adjusting a width at which the coating liquid is applied (hereinafter referred to as a coating width) and a width at which the coating liquid is not applied (hereinafter referred to as a non-coating width).

In the off-line coating method described above as well, end portions of the web may remain uncoated to avoid consuming more coating liquid than necessary by adjusting the coating width according to a product width. It is important for improving productivity that the coating device has a function of adjusting the coating width.

Therefore, for example, Patent Literature 2 discloses a method in which both end portions of a web are lifted by members or the like and brought into non-contact with a coating device to form a non-coating width at the end portions. In addition, Patent Literature 3 discloses a coating device having a structure enabling the device to have a width that varies depending on a coating width. Further, Patent Literature 4 discloses a method for adjusting a width of a liquid pool in a container. The method disclosed in Patent Literature 4 is capable of freely adjusting a coating width during coating with good workability, thereby changing the coating width without deteriorating productivity.

### PATENT LITERATURE

Patent Literature 1: JP 2004-74147 A
Patent Literature 2: JP 2020-961 A
Patent Literature 3: JP 2009-160552 A
Patent Literature 4: JP 2007-326080 A

### SUMMARY OF THE INVENTION

However, in the method disclosed in Patent Literature 2, creases or the like may be generated on the web, which may adversely affect conveyance. In addition, in the coating device disclosed in Patent Literature 3, when the product type is switched, it is necessary to disassemble the coating device and then reassemble the coating device, which deteriorates productivity. Furthermore, in the method disclosed in Patent Literature 4, it is not possible to separate an upstream side and a downstream side from each other, because an upstream container and a downstream container communicate with each other in a member-slidable region in which the coating width is changed. As a result, it is not possible to individually adjust flow rates of the coating liquid supplied to the upstream side and the downstream side of the coating bar depending on the coating width.

The present invention provides a coating device and a coating method capable of individually controlling flow 20 rates of coating liquid upstream and downstream of a coating bar, forming non-coated portions at end portions of a web, and adjusting a coating width without deteriorating productivity.

According to the present invention for solving the above-described problems, a coating device for coating a web that is traveling with coating liquid includes: a coating bar extending in a web width direction; a partition disposed below an axial center of the coating bar in a vertical direction, the partition extending in the web width direction; and an upstream container and a downstream container disposed on an upstream side and a downstream side in a web conveyance direction, respectively, with the partition interposed between the upstream container and the downstream container, the upstream container and the downstream container including side plates disposed inward in the web width direction with respect to both ends of the partition on a web width direction side, the upstream container and the downstream container being configured to store the coating liquid, in which the partition is a portion that separates the upstream container and the downstream container from each other, and has a flow path for discharging the coating liquid from a position within a range of a web width and outside the side plates in the web width direction.

The coating device according to the present invention preferably has one or more of the following aspects (1) to (6).
(1) The flow path for discharging the coating liquid is a flat surface that is inclined downward in the vertical direction from a position below the coating bar in the vertical direction toward either the upstream side or the downstream side in the web conveyance direction.
(2) The flow path for discharging the coating liquid is at least one groove having a bottom surface that is inclined downward in the vertical direction from a position below the coating bar in the vertical direction toward either the upstream side or the downstream side in the web conveyance direction.
(3) The flow path for discharging the coating liquid is at least one hole extending from a position below the coating bar in the vertical direction to a side surface of the partition on either the upstream side or the downstream side in the web conveyance direction through an inside of the partition.
(4) The side plates are slidable in the web width direction.
(5) The partition is configured to support the coating bar from below.
(6) Supports configured to support the coating bar from below are spaced apart in the web width direction.

However, a configuration of the coating device according to the present invention does not include the web to be coated.

A method for producing a web with a coating film according to the present invention by using the coating device according to the present invention includes coating the web with the coating liquid by pressing the coating bar against the web conveyed from the upstream side to the downstream side at a predetermined speed while supplying the coating liquid to the upstream container and the downstream container.

Next, meanings of terms in the present invention will be described.

The “web conveyance direction” refers to a direction in which the web coated by the coating device is conveyed.

The “web width direction” refers to a direction of a width of the web coated by the coating device.

The “upstream side” refers to a side on which the coating device is installed toward a direction from which the web is conveyed when the coating device is installed in a web conveyance line.

The “downstream side” refers to a side on which the coating device is installed toward a direction to which the web is conveyed when the coating device is installed in the web conveyance line.

In each drawing of the present application, a longitudinal direction of the coating device is defined as a Y direction, a direction orthogonal to the Y direction is defined as an X direction, and a direction orthogonal to the X direction and the Y direction is defined as a Z direction. The X direction corresponds to the conveyance direction of the web, and the Z direction corresponds to the vertical direction of the coating device.

In the coating device and the coating method according to the present invention, outside the coating width, the coating liquid is discharged from the coating device and does not adhere to the coating bar, so that non-coated portions can be formed at end portions of the web under any coating conditions, and the coating width can be adjusted without deteriorating productivity.

### BRIEF DESCRIPTION OF THE DRAWINGS

FIG. 1 is a schematic perspective view of a first coating device according to the present invention.

FIG. 2 is a cross-sectional view of an XZ plane outside side plates of the coating device of FIG. 1.

FIG. 3 is a top view of the coating device of FIG. 1.

FIG. 4 is a schematic perspective view of the coating device of FIG. 1 from which a coating bar is removed.

FIG. 5 is a schematic perspective view of a second coating device according to the present invention.

FIG. 6 is a view illustrating a state in which coating liquid is supplied to the second coating device according to the present invention from which a coating bar is omitted.

FIG. 7 is a cross-sectional view of an XZ plane outside side plates of a conventional coating device.

FIG. 8 is a view illustrating a state in which coating liquid is supplied to the conventional bar coating device from which a coating bar is omitted.

FIG. 9 is a schematic perspective view of a third coating device according to the present invention.

FIG. 10 is a schematic perspective view of a fourth coating device according to the present invention.

FIG. 11 is a cross-sectional view of an XZ plane in a portion where supports exist of the coating device of FIG. 10.

FIG. 12 is a schematic perspective view of the coating device of FIG. 10 in the portion where the supports exist.

FIG. 13 is a cross-sectional view of an XZ plane of a coating device, illustrating a coating state when coating liquid supplied to an upstream container is insufficient.

FIG. 14 is a cross-sectional view of an XZ plane of a coating device, illustrating a coating state when coating liquid supplied to a downstream container is insufficient.

FIG. 15 is a schematic perspective view of a coating device according to Patent Literature 4 from which a coating bar is removed.

### DETAILED DESCRIPTION OF EMBODIMENTS OF THE INVENTION

Hereinafter, examples of an embodiment of the present invention will be described with reference to the drawings.

### [First Coating Device]

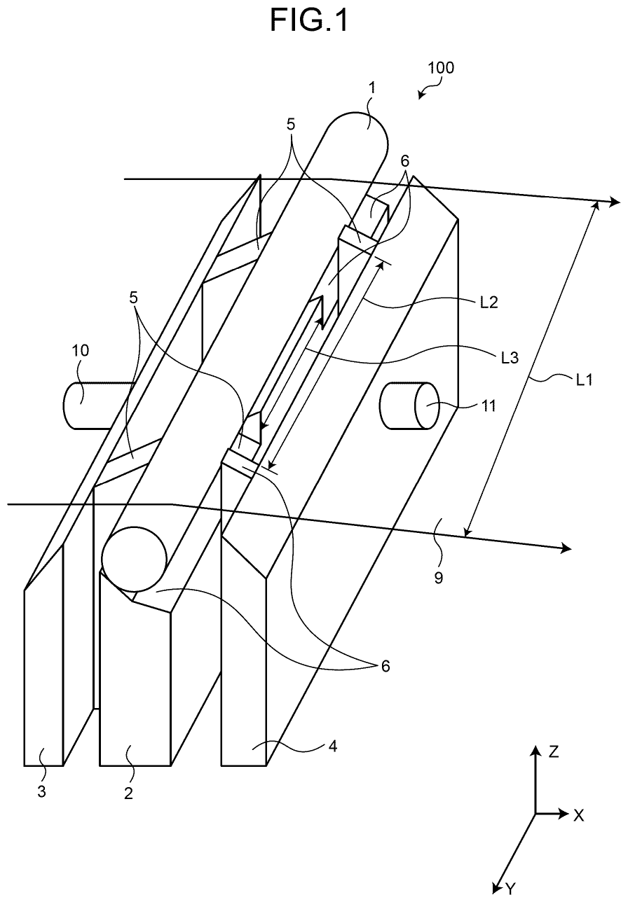

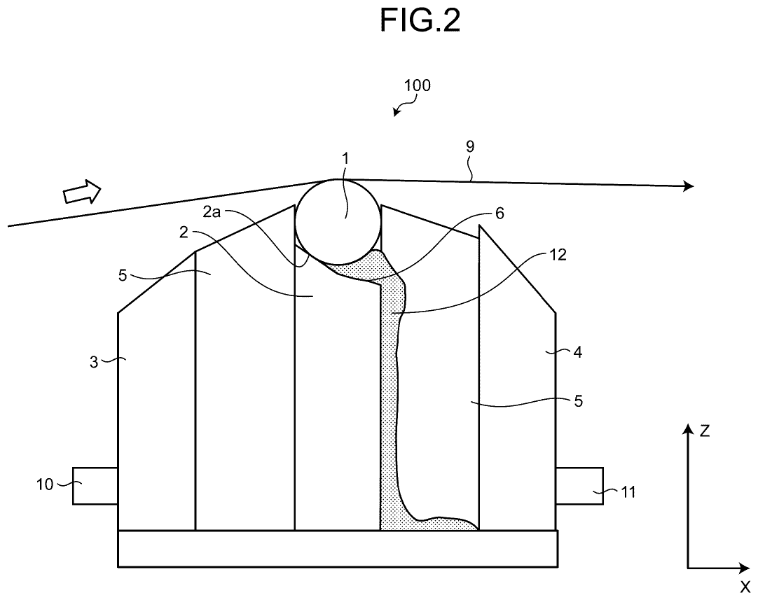

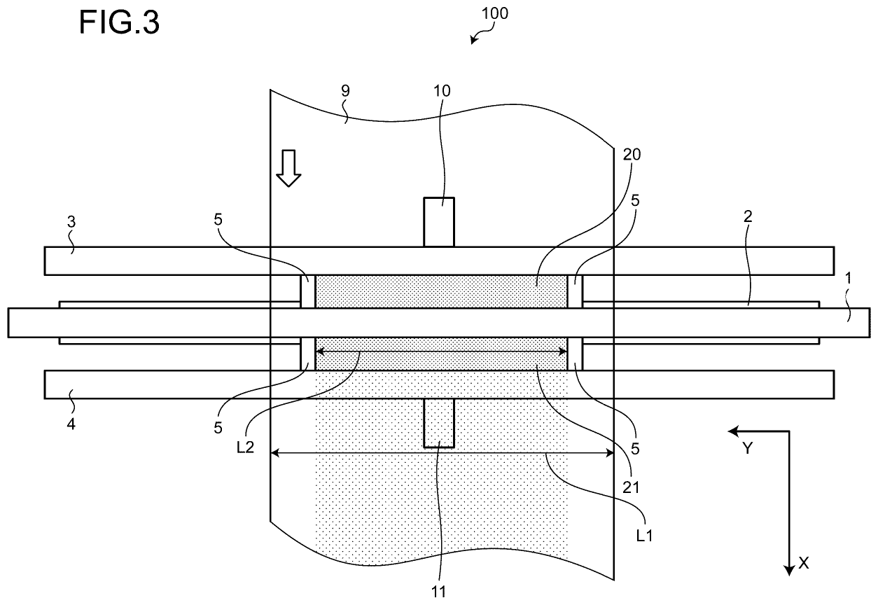

A device configuration of a first coating device according to the present invention will be described. FIG. 1 is a schematic perspective view of the first coating device, and FIG. 2 is a cross-sectional view of an XZ plane of the first coating device, illustrating a state in which coating liquid is discharged outside a side plate in a longitudinal direction of the coating device. FIG. 3 is a top view of an XY plane of the first coating device when viewed from above in the vertical direction.

Refer to FIGS. 1 and 3. A first coating device 100 includes: a coating bar 1 extending in a web width direction with respect to a web 9; a partition 2 disposed below an axial center of the coating bar 1 in a vertical direction and extending in the web width direction; an upstream main plate 3 and a downstream main plate 4 disposed in parallel on an upstream side and a downstream side, respectively, in a web conveyance direction with the partition 2 interposed therebetween; side plates 5 disposed inward in the web width direction with respect to side both ends of the partition 2 on a web width direction side; a bottom plate (not illustrated) provided in contact with the partition 2, the upstream main plate 3, the downstream main plate 4, and the side plates 5 and constituting an upstream container 20 and a downstream container 21 together with the partition 2, the upstream main plate 3, the downstream main plate 4, and the side plates 5. The upstream container 20 and the downstream container 21 are supplied with coating liquid 12 from an upstream container coating liquid supply port 10 and a downstream container coating liquid supply port 11, respectively. A width L2 between the two side plates 5 is a width across which the web 9 is coated with the coating liquid, that is, a width set as a desired coating width. The side plates 5 may be slidable in the web width direction. In this case, the range in which the side plates 5 slide serves as a range in which the coating width is adjusted.

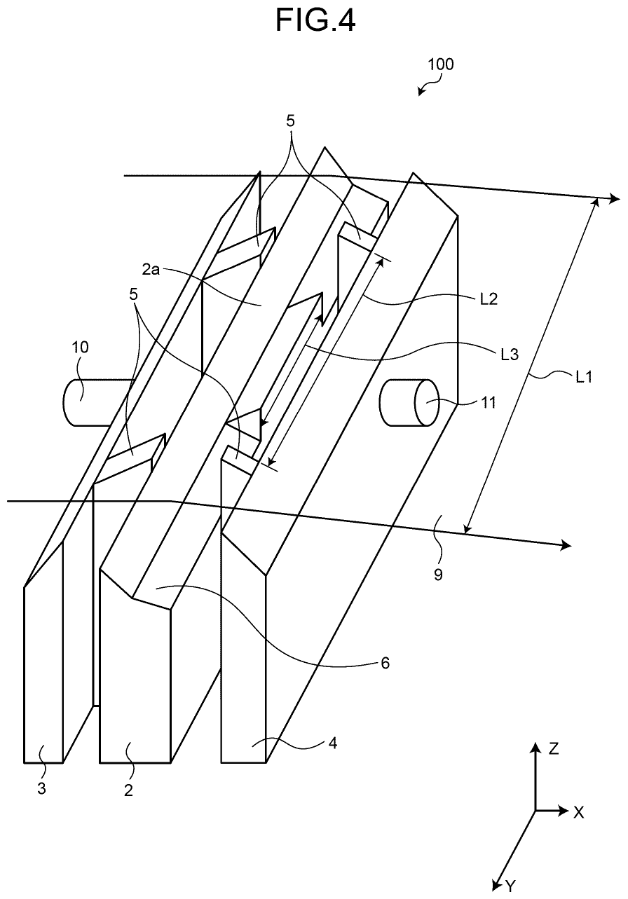

Refer to FIGS. 2 and 4. FIG. 4 is a schematic perspective view of the first coating device from which the coating bar is removed. The partition 2 is a plate-shaped portion, with V-shaped support portion 2a formed on a side supporting the coating bar 1 thereof, and the coating bar 1 is supported by the support portion 2a. In the first coating device 100, the support portion 2a has a V shape, but may have an arc shape as long as the coating bar 1 can be supported. The support portion 2a of the partition 2 has an inclined surface 6 formed to discharge the coating liquid from a position within a range of a web width L1 of the web 9 to be coated and outside the side plates 5 in the web width direction. The inclined surface 6 is formed by cutting out a surface on the downstream side constituting the support portion 2a, and functions as a flow path through which the coating liquid flows out from between the coating bar 1 and the support portion 2a. The inclined surface 6 is formed to be inclined downward in the vertical direction from a position below the coating bar 1 in the vertical direction toward the downstream side in the web conveyance direction. The inclined surface 6 may be a flat surface inclined downward in the vertical direction toward the upstream side in the web conveyance direction as long as the coating liquid can be discharged from between the coating bar 1 and the partition 2. In the present embodiment, both end portions of the partition 2 entirely have inclined surfaces, but inclined surfaces 6 may be provided only around the side plates 5, and the support portion 2a may remain without forming inclined surfaces 6 on the end sides of the partition 2.

### [Coating Bar]

As the coating bar 1, for example, a wire bar in which grooves are formed by winding a wire on an outer circumferential surface of the bar, a rolling bar in which grooves are formed by rolling processing on an outer circumferential surface of the bar, a gravure roll having a small diameter, or the like can be used. The material of the coating bar 1 is preferably stainless steel, and particularly preferably SUS304 or SUS316. The surface of the coating bar 1 may be subjected to a surface treatment such as hard chromium plating. If the diameter of the coating bar 1 is too large, a streak-like coating defect called a rib streak is likely to occur along the conveyance direction, and if the diameter of the coating bar 1 is too small, the deflection of the coating bar 1 is large. Therefore, for example, the diameter of the coating bar is preferably in the range of 4 to 20 mm. The rotation of the coating bar may be a so-called driven rotation in which the coating bar 1 is pressed against the web 9 and rotated by a frictional force between the coating bar 1 and the web 9, or may be rotated by a driving device such as a motor. In a case where the coating bar 1 is rotated by the driving device, in order to prevent the web 9 from being scratched, the coating bar 1 is preferably rotated at substantially the same speed as the conveyance speed of the web 9 in the conveyance direction of the web 9. Here, the “substantially the same speed” means that the coating bar 1 is rotated with a speed difference between the circumferential speed of the coating bar 1 and the conveyance speed of the web 9 within a range of +10%. However, the coating bar 1 may be rotated at a speed different from the conveyance speed of the web 9 or in a direction opposite to the conveyance direction of the web 9 if a scratch on the web does not cause a problem in a certain use of a product or the like.

### [Side Plate]

The gap between the side plate 5 and each component is preferably 0.3 mm or less in order to prevent the coating liquid from leaking to the outside of the coating width to enhance the sealability of the container as much as possible and not to impair the slidability. The material of the side plate 5 is not particularly limited, but a resin material having high slidability is preferable. As a means for sliding the side plate 5 in the width direction, a motor or an air cylinder may be used, or the side plate 5 may be manually slid. By making the side plate 5 slidable without disassembling the device, the coating width can be easily adjusted at the time of switching a product type.

### [Partition]

The partition 2 is installed to partition the flow path of the coating liquid supplied to the upstream side and the downstream side of the coating bar 1 in the web conveyance direction. As long as the amounts of the coating liquid to be supplied to the upstream side and the downstream side can be adjusted, the shape of the partition 2 is not particularly limited. If the partition 2 is sufficiently close to the coating bar 1, the partition 2 does not need to contact the coating bar 1, but a gap between the coating bar 1 and the partition 2 at a position at which the partition 2 is closest to the coating bar is preferably 1 mm or less.

### [Second Coating Device]

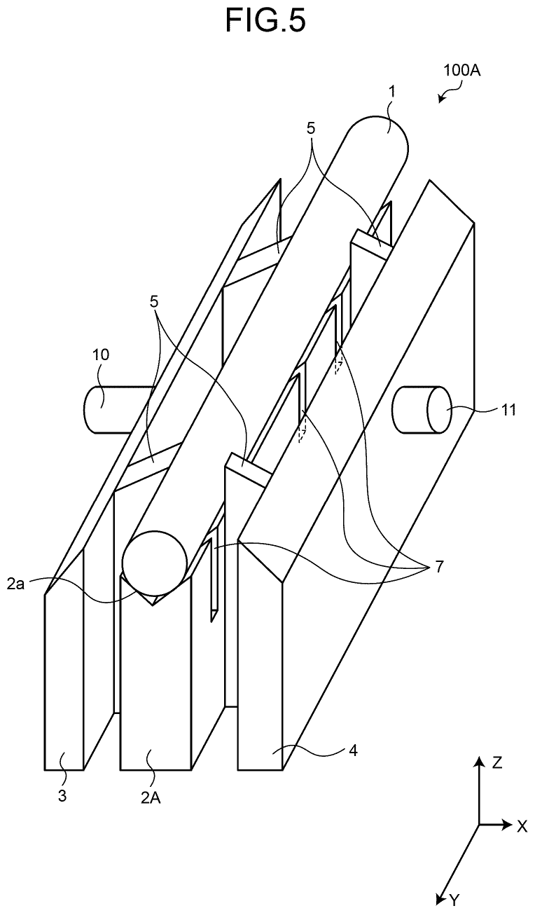

Refer to FIG. 5. FIG. 5 is a schematic perspective view of a second coating device 100A according to the present invention. In the second coating device 100A, four grooves 7 are provided in a support portion 2a of a partition 2A as flow paths for discharging the coating liquid, the four grooves 7 each having a bottom surface inclined downward in the vertical direction from a position below the coating bar 1 in the vertical direction toward the downstream side in the web conveyance direction. It is sufficient that at least one groove 7 is provided within a range of the web width of the partition 2A and outside the side plates 5 in the web width direction, and it is preferable that grooves 7 are provided at both ends, respectively, within the range of the web width of the partition 2A and outside the side plates 5 in the web width direction. The reason why the four grooves 7 are provided in the second coating device 100A is to cope with a change in web width, and more than four grooves 7 may be provided. The bottom surface of the groove 7 may be inclined downward in the vertical direction toward the upstream side in the web conveyance direction. The size of the groove 7 is preferably determined according to the flow rate of the coating liquid to be discharged. The shape of the cross section of the groove 7 in the web width direction may be rectangular, elliptical, or the like, and is not particularly limited as long as it satisfies a discharge function. In a case where there is a portion where the coating bar 1 is not supported within a range in which the coating width is adjusted, if the range in which the coating width is adjusted is significantly widened, there is a concern that the deflection of the coating bar 1 at the portion increases, deteriorating the coating quality. In the second coating device 100A, since the partition 2A directly contacts and supports the coating bar 1 from below across the entire coating width, even though the coating bar 1 cannot be supported at a portion where the groove 7 is formed, the coating bar 1 is not supported locally, which does not greatly affect the deflection of the coating bar 1. Therefore, coating can be stably performed without lowering the coating quality even in the range in which the coating width is adjusted, and the range in which the coating width can be adjusted is dramatically expanded.

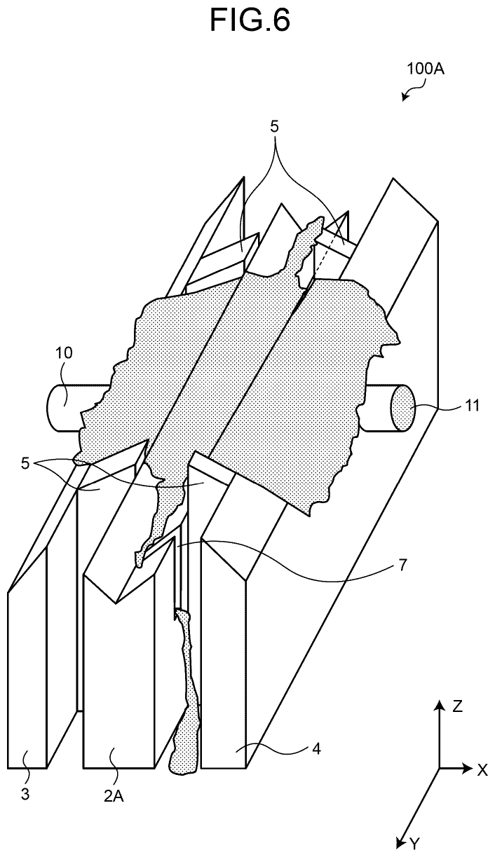

Refer to FIG. 6. FIG. 6 is a view illustrating a state in which the coating liquid 12 is supplied to a second coating device 100A from which a coating bar 1 is omitted. The coating liquid 12 supplied from an upstream container coating liquid supply port 10 and a downstream container coating liquid supply port 11 are accumulated in an upstream container 20 and a downstream container 21, respectively, and spread from an upper surface toward both end portions in the web width direction of the partition 2A along the support portion 2a. Since the grooves 7 are located outside the side plates 5 in the web width direction in the support portion 2a of the partition 2A, the coating liquid is discharged from the grooves 7 to the outside of each of the containers, and the coating liquid is not accumulated on the upper surface of the partition 2A. Therefore, the coating bar 1 is not wetted with the coating liquid outside the grooves 7, along which the coating liquid is discharged, in the web width direction, and a non-coated portion can be formed.

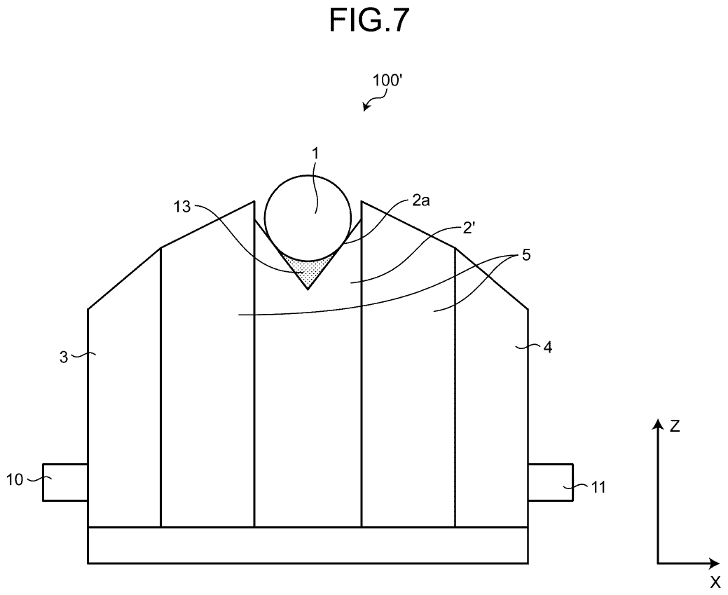

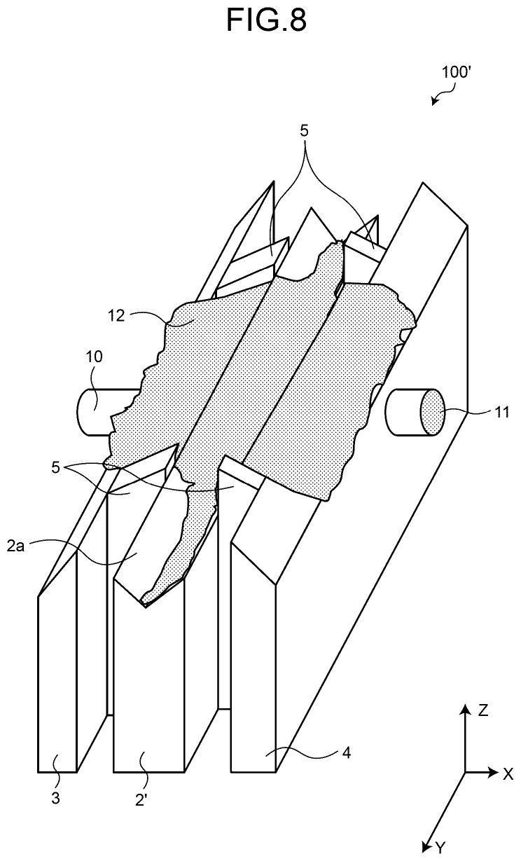

Refer to FIGS. 7 and 8. FIG. 7 is a cross-sectional view of an XZ plane at an end in the width direction of a conventional coating device 100′. FIG. 8 is a view illustrating a state in which coating liquid is supplied to the conventional coating device 100′ from which a coating bar 1 is omitted. As illustrated in FIG. 7, in the conventional coating device 100′, a support portion 2a of a partition 2′ supporting the coating bar 1 extends with the same cross section over the entire area in the web width direction. In order to support the coating bar 1, it is necessary to bring the partition 2′ into contact with the coating bar 1 from below. However, since the coating bar 1 has a cylindrical shape and considering that the support portion 2a of the partition 2′ generally has a V shape, the coating liquid is accumulated in a gap 13 between the coating bar 1 and the support portion 2a provided in the partition 2′. The coating liquid spreads in the width direction along the gap 13, and the coating liquid is not discharged. Therefore, as illustrated in FIG. 8, the coating liquid spreads to the outside of the side plates 5, and the coating bar 1 is wet. That is, the web is coated with the coating liquid even outside the side plates 5, and a non-coated portion cannot be formed.

### [Third Coating Device]

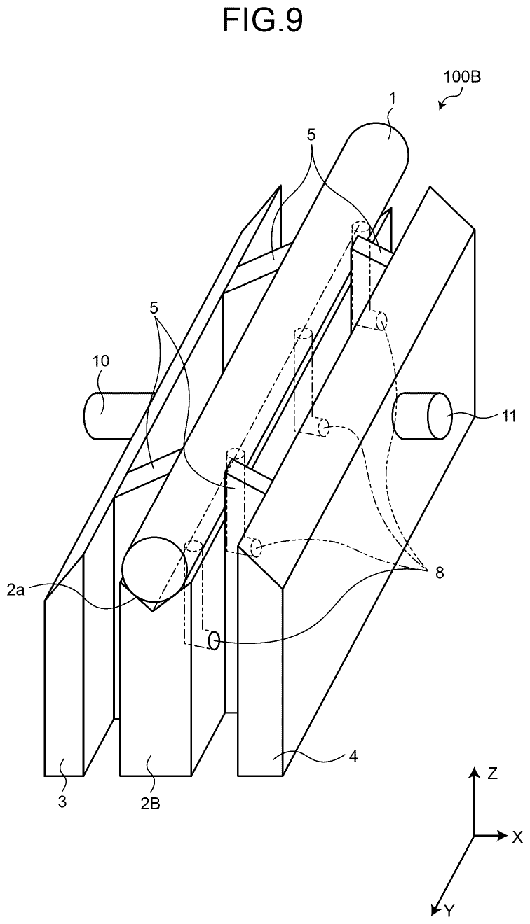

Refer to FIG. 9. FIG. 9 is a schematic perspective view of a third coating device 100B according to the present invention. The third coating device 100B has, as flow paths for discharging coating liquid, four holes 8 each extending from a position below the coating bar 1 in the vertical direction through the inside of a partition 2B to a side surface of the partition 2B on the downstream side in the web conveyance direction. It is sufficient that at least one hole 8 is provided within a range of the web width of the partition 2B and outside the side plates 5 in the web width direction, and it is preferable that holes 8 are provided at both ends, respectively, within the range of the web width of the partition 2B and outside the side plates 5 in the web width direction. The reason why the four holes 8 are provided in the third coating device 100B is to cope with a change in web width, and more than four holes 8 may be provided. The hole 8 may extend to a side surface of the partition 2B on the upstream side in the web conveyance direction through the inside of the partition 2B. The cross-sectional shape of the hole 8 is not limited to a circle, an ellipse, a rectangle, or the like, and the size of the hole 8 is determined according to the flow rate of the coating liquid to be used. In the coating device 100B, the partition 2B directly contacts and supports the coating bar 1 from below, and the coating bar 1 can be supported even within the range in which the hole 8 is formed. Therefore, the deflection of the coating bar 1 is not aggravated, and coating can be stably performed without deteriorating the coating quality even within the range in which the coating width is adjusted.

### [Fourth Coating Device]

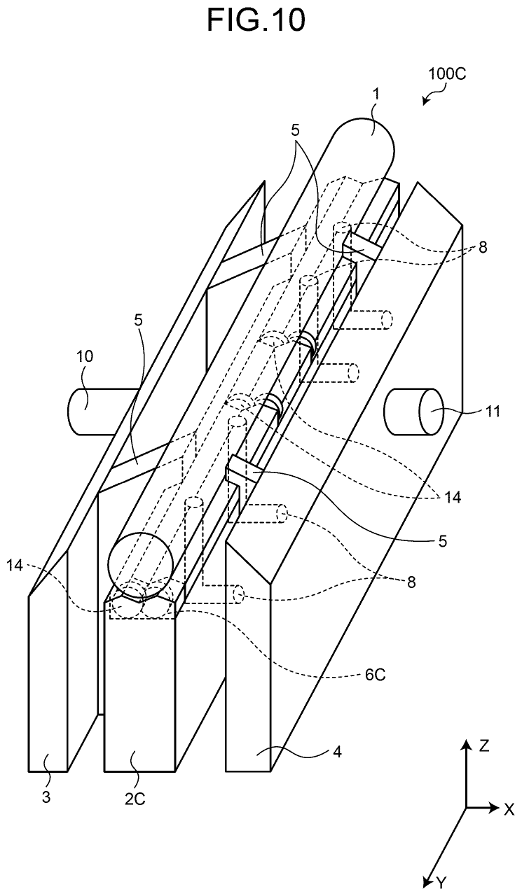

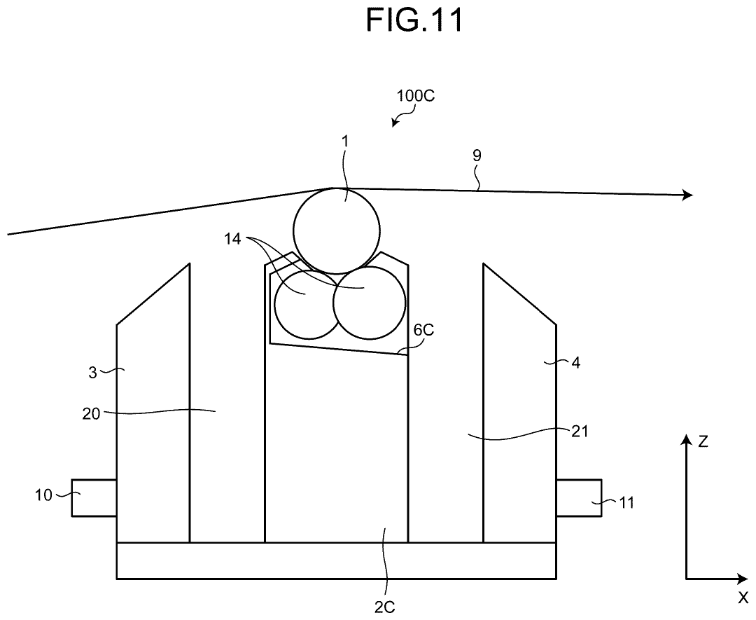

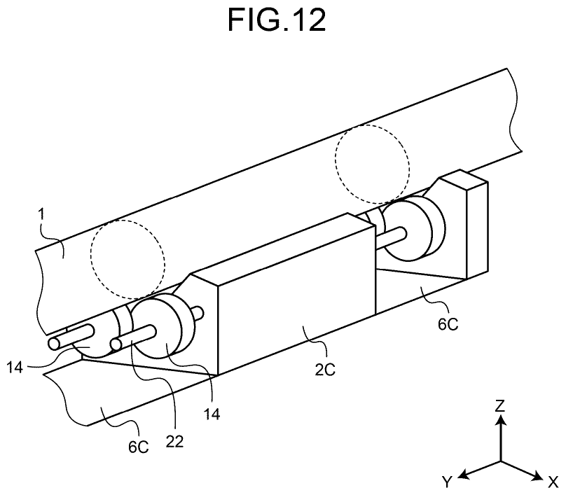

Refer to FIGS. 10, 11, and 12. FIG. 10 is a schematic perspective view of a fourth coating device 100C according to the present invention. FIG. 11 is a cross-sectional view of an XZ plane in a portion where supports 14 exist of the fourth coating device 100C. FIG. 12 is a schematic perspective view of a partition 2C in the portion where the supports 14 exist. As illustrated in FIG. 10, the fourth coating device 100C is a coating device in which the supports 14 that support the coating bar 1 from below are spaced apart in the web width direction, and the partition 2C extending in the web width direction is disposed below an axial center of a coating bar 1 in the vertical direction. As illustrated in FIG. 11, also in a cross section where the supports 14 exist, the partition 2C extending in the web width direction partitions the coating bar 1 into an upstream side and a downstream side below the axial center of the coating bar 1 in the vertical direction. In FIGS. 10 and 11, it is illustrated that, the fourth coating device 100C has, as flow paths for discharging coating liquid, four holes 8 each extending from a position below the coating bar 1 in the vertical direction in a portion where the supports 14 do not exist in the web width direction through the inside of the partition 2C to a side surface of the partition 2C on the downstream side in the web conveyance direction, and has an inclined surface 6C downward in the vertical direction from a position below the coating bar 1 in the vertical direction toward the downstream side in the web conveyance direction in a portion where the supports 14 exist. It is sufficient that at least one hole 8 is provided within a range of the web width of the partition 2C and outside the side plates 5 in the web width direction, and it is preferable that holes 8 are provided at both ends, respectively, within the range of the web width of the partition 2C and outside the side plates 5 in the web width direction. The reason why the four holes 8 are provided in the fourth coating device 100C is to cope with a change in web width, and more than four holes 8 may be provided. The flow paths may be only grooves or holes intermittently arranged without providing inclined surfaces 6C. FIG. 12 illustrates an aspect in which the support 14 is a roller. The outer circumference of the roller as the support 14 is in contact with the coating bar 1 and the support 14 rotates together with the coating bar 1 about a shaft 22 attached to the partition 2C as a rotation axis, thereby reducing the wear of the coating bar 1 and the support 14. Although it is illustrated in FIGS. 10, 11, and 12 that the support 14 is a roller, the support 14 may be a V-shaped support, an arc-shaped support, a ball that supports the coating bar 1 while rotating, or the like, and the aspect of the support 14 is not limited as long as the coating bar 1 can be supported. Concerning the material of the support 14, it is preferable to use a material having hardness lower than that of the coating bar 1 for a surface layer of the support in order to reduce the wear of the coating bar 1.

If the interval at which the supports 14 are arranged in the longitudinal direction of the coating bar 1 is too wide, the deflection of the coating bar 1 increases. Thus, it is preferable that the interval at which the supports 14 are arranged is narrow. As a guide, the coating bar 1 may be disposed so that the deflection of the coating bar 1 is 10 μm or less. An amount of deflection can be obtained from the formula of material mechanics, using the secondary moment of cross section and Young's modulus of the coating bar 1, by applying a reaction force in the out-of-plane direction of the web 9 calculated from the tension applied in the traveling direction of the web 9 as a uniformly distributed load applied to the coating bar 1, with the support 14 as a support point. In this coating device, since the coating bar 1 is supported by the support 14 in contact with the coating bar 1 from below even in a range in which the coating width is adjusted, the deflection of the coating bar 1 can be suppressed, and coating can be stably performed without deteriorating the coating quality. Similarly, in the first coating device 100 described above as well, the support 14 may be provided in the range of the inclined surface 6 of the partition 2. By providing the support 14, the deflection of the coating bar 1 is suppressed even in the range of the inclined surface 6, that is, the range in which the coating width is adjusted, thereby stably performing coating without deteriorating the coating quality. Examples of materials for the support 14 include metals such as iron, stainless steel, aluminum, and copper, synthetic resins such as nylon, acrylic resin, vinyl chloride resin, and tetrafluoroethylene, rubber, and the like. In addition, the shape of the support 14 may be a plate shape or a block shape.

### [Coating Method]

A method for coating a web using any of the first to fourth coating devices 100, 100A, 100B, and 100C will be described. The coating liquid 12 is supplied from the upstream container coating liquid supply port 10 and the downstream container coating liquid supply port 11 into the upstream container 20 and the downstream container 21, respectively. The coating device is raised with respect to the web 9 that is being conveyed, and the coating bar 1 is pressed against a lower surface of the web 9 from below the web 9 to coat the web 9. The angle at which the web 9 wraps the coating bar 1 is not particularly limited, but is more preferably 0 degrees or more and 20 degrees or less. As the coating liquid supply means, a gear pump, a diaphragm pump, or a Mohno pump, which has quantitativity and low pulsation is preferable. In addition, the coating liquid 12 discharged from the pump may be supplied to the container via a filter or a defoaming means. The coating liquid supplied from coating liquid tank to the container via the pump and the supply port circulates to the coating liquid tank via the flow path of the coating device 100, 100A, 100B, or 100C. Before coating is started, it is preferable to set the supply flow rate of the coating liquid to be sufficient so that the coating liquid is fed to defoam the inside of the supply flow path and the inside of the container of the coating device. At this time, it is preferable to remove the coating bar 1 and confirm that bubbles have disappeared from the upstream container 20 and the downstream container 21 while the coating liquid 12 is continuously flowing.

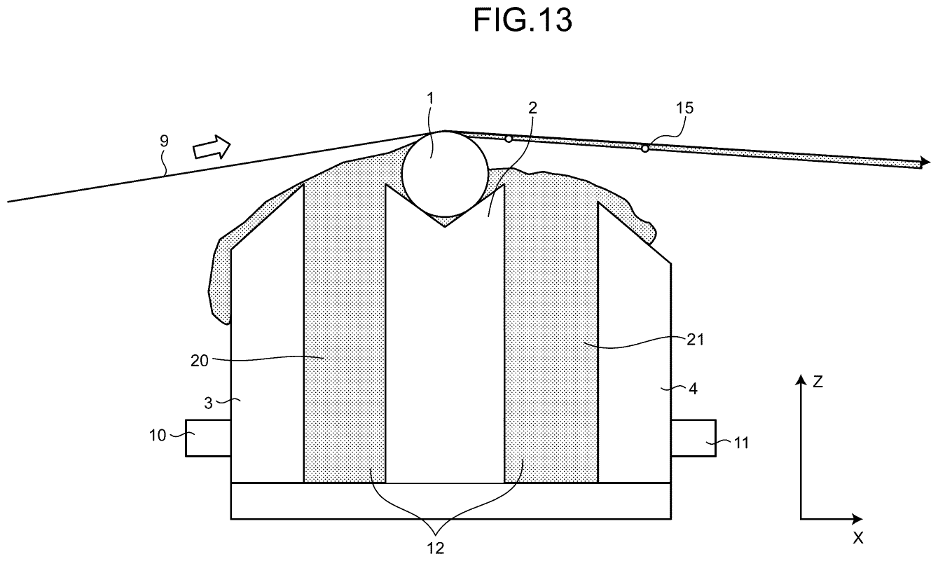

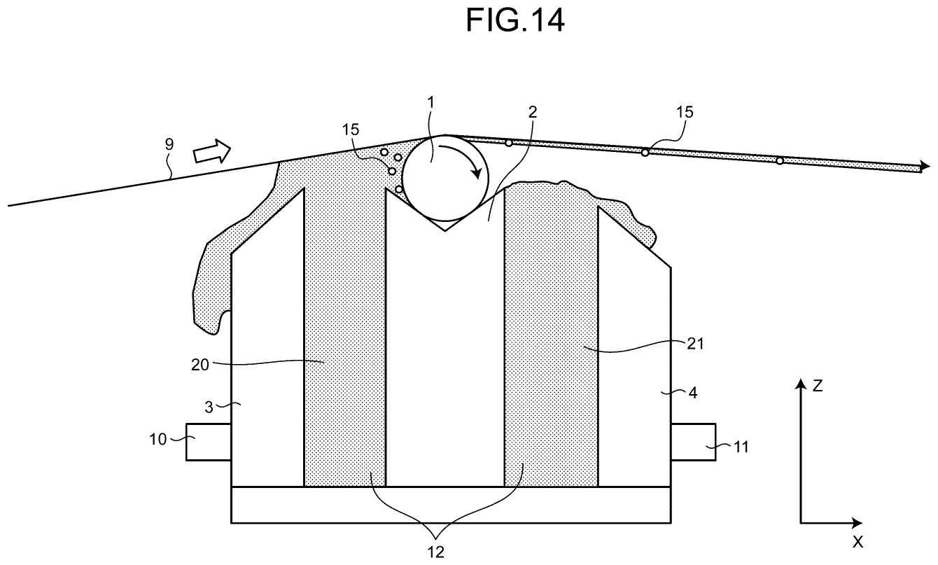

Refer to FIGS. 13 and 14. FIG. 13 is a view illustrating a state where the coating liquid 12 supplied to the upstream container 20 is insufficient, and FIG. 14 is a view illustrating a state where the coating liquid 12 supplied to the downstream container 21 is insufficient, each being a cross-sectional view of an XZ plane of the coating device. During coating, when the amount of the coating liquid 12 supplied to the upstream container 20 is small, air accompanying by the web 9 reaches the coating bar 1, whereby wetting failure occurs, the air passes between the web 9 and the coating bar 1, and air bubbles 15 are mixed into a coating film, as illustrated in FIG. 13. On the other hand, when the amount of the coating liquid 12 supplied to the downstream container 21 is small, air accompanied by the rotation of the coating bar 1 on the downstream side of the coating bar 1 passes between the coating bar 1 and the partition 2, air bubbles 15 are generated on the upstream side of the coating bar 1, and then the air bubbles pass between the web 9 and the coating bar 1, and the air bubbles 15 are mixed into a coating film, as illustrated in FIG. 14. When the air bubbles 15 are mixed into the coating film in this manner, a defect such as an air-bubble-derived coating escape shape occurs. Alternatively, when the air bubbles 15 continue to stay between the web 9 and the coating bar 1, a streak-like defect occurs. On the other hand, when the flow rate of the coating liquid that is being supplied is too high, there is a problem that foreign substances or air bubbles passing through the filter increase. Therefore, it is preferable to set the flow rate to a minimum flow rate at which bubbles are not generated, by adjusting the balance between the flow rate of the coating liquid 12 supplied to the upstream container 20 and the flow rate of the coating liquid 12 supplied to the downstream container 21. The coating liquid 12 supplied to the upstream container 20 and the downstream container 21 is preferably adjusted depending on coating conditions such as the thickness of the coating film, the conveyance speed of the web 9, and the rotation speed of the coating bar 1.

The web targeted by the present coating method is not particularly limited as long as it is in the form of a long sheet such as paper, a film, or a metal foil.

### [Coating Liquid]

The viscosity of the coating liquid 12 used in the coating device according to the present embodiment is preferably 0.1 Pa's or less. If the viscosity of the coating liquid 12 is high, a ribbing phenomenon may occur, resulting in coating streaks.

The coating amount of the coating liquid 12 is preferably 100 g/m² or less in a wet state immediately after coating. In general, in the bar coating method, the lower the coating amount, the better the coating quality, and therefore, it is more preferable that the coating weight is in the range of 4 to 50 g/m². The coating amount can be adjusted by the size of the groove formed in the coating bar 1. The size of the groove can be changed by changing the wire diameter of the wire to be wound in a case where the coating bar 1 is a wire bar, and by performing rolling processing using a die having a different groove depth and/or a different groove pitch in a case the coating bar 1 is a rolling bar.

### EXAMPLES

Next, the above-described embodiment will be specifically described based on examples, but the above-described embodiment is not necessarily limited to the following examples.

### Example 1

A chip of polyethylene terephthalate (hereinafter, abbreviated as PET) having a limiting viscosity (also referred to as an intrinsic viscosity) of 0.62 dl/g (measured in o-chlorophenol at 25° C. according to the standard of JIS K7367-5 (2000 edition)) was sufficiently vacuum-dried at 160° C. The vacuum-dried chip was fed to an extruder and melted at 285° C. The molten polymer was extruded into a sheet from a T-shaped die, wound around a mirror-finished cast drum having a surface temperature of 23° C. using an electrostatic application casting method, and cooled and solidified into an unstretched film. Subsequently, in a longitudinal stretching machine, the unstretched film was heated by a group of rolls heated to 80° C., and stretched 3.2 times in the longitudinal direction while being further heated by an infrared heater, and then cooled by a cooling roll adjusted to 50° C. to obtain a uniaxially stretched resin film. The width of the resin film was 1700 mm. Subsequently, the coating liquid 12 was applied onto a lower surface of the resin film traveling at a speed of 200 m/min using the first coating device 100 illustrated in FIGS. 1 and 2 as a coating device. Subsequently, in a transverse stretching machine, the resin film coated with the coating liquid 12 was guided into an oven at 90° C. and heated, and then the coating liquid 12 was dried in the oven at 100° C. In addition, the resin film was stretched 3.7 times in the width direction, and the resin film was heat-fixed while being relaxed by 5% in the width direction in the oven at 220° C. In this way, a biaxially stretched film having a layer of the coating liquid 12 formed on one surface thereof was obtained. The tension between the longitudinal stretching machine and the transverse stretching machine was controlled by a dancer roll such that the tension per unit width applied in the traveling direction of the resin film was 8000 N/m.

The coating liquid 12 was a mixed liquid obtained by adding 5 parts by mass of a melamine-based crosslinking agent (manufactured by Nippon Carbite Industries Co., Ltd.: MW-390) and 1 part by mass of colloidal silica particles having an average particle size of 0.1 μm to 100 parts by mass of an emulsion of a polyester copolymer (components: terephthalic acid 90 mol %, sodium 5-sulfoisophthalic acid 10 mol %, solvent: ethylene glycol 96 mol %, neopentyl glycol 3 mol %, diethylene glycol 1 mol %). The coating liquid 12 had a viscosity of 2 mPa·s at a temperature of 25° C.

This coating liquid was supplied to the upstream container 20 and the downstream container 21 from the upstream container coating liquid supply port 10 and the downstream container coating liquid supply port 11, respectively, of the first coating device 100 of FIG. 1 by using two Mono pumps (manufactured by Heishin Engineering & Equipment Co., Ltd.). As the coating bar 1, a stainless steel round bar material having a diameter of 12.7 mm and a length of 2000 mm around which a wire having a linear shape of 0.1 mm was wound (manufactured by Kano Shoji Co., Ltd.) was used. The side plates 5 were arranged such that the side plate interval L2 was 1600 mm (L3: 1000 mm).

Using the first coating device 100, coating was performed while the coating bar 1 was pressed against the web 9 that is being conveyed by a driven rotation. The coating bar 1 was supported by the V-shaped support portion 2a of the partition 2. As illustrated in FIGS. 1 and 2, the partition 2 was formed to have an inclined surface 6 obtained by cutting off the downstream side of the V-shape in the coating adjustment width (300 mm on one side). The results of the coating are shown in Table 1. The width of the coating on the web was L2+8 mm with respect to the side plate interval L2 (1600 mm), and it was confirmed that the film could be formed without any problem. In addition, in order to remove bubbles from the supply flow path and the container of the coating device, the coating bar 1 was removed once, the coating liquid continuously flowed at a supply amount of 50 L/min for 3 minutes, and then the coating bar 1 was attached back to perform coating. In this case, a non-coated portion could be formed without any problem. The coating liquid supply amount with no bubbles caught on both the upstream side and the downstream side was 10 L/min on the upstream side and 27 L/min on the downstream side.

### Example 2

As illustrated in FIG. 5, the coating bar 1 was supported across the entire width by the V-shaped support portion 2a of the partition 2A using the second coating device 100A. For the coating adjustment width of the partition 2A, the V-shaped support portion 2a having grooves 7 intermittently dug in the web width direction was applied. The grooves 7 had a width of 10 mm and a depth of 20 mm, and a distance between the centers of the grooves in the web width direction was 140 mm. Except for that, coating was performed in the same manner as in Example 1. The results of the coating are shown in Table 1. The width of the coating on the web was L2+10 mm with respect to the width L2 (1600 mm) between the side plates regulated by the side plates 5, and it was confirmed that the film could be formed without any problem. In the same manner as in Example 1, even though coating was performed again after the coating liquid continuously flowed at a supply amount of 50 L/min for 3 minutes, a non-coated portion could be formed. The coating liquid supply amount with no bubbles caught on both the upstream side and the downstream side was 10 L/min on the upstream side and 25 L/min on the downstream side.

### Example 3

As illustrated in FIG. 9, the coating bar 1 was supported across the entire width by the V-shaped support portion 2a of the partition 2B using the third coating device 100B. For the coating adjustment width of the partition 2B, the V-shaped support portion 2a having holes 8 intermittently arranged in the web width direction was applied. Each of the holes 8 had a diameter of 8 mm, and was formed to communicate with the outside of the partition 2B at a position 10 mm downward in the Z direction. A distance between the centers of the holes in the web width direction was 142 mm. Except for that, coating was performed in the same manner as in Example 1. The results of the coating are shown in Table 1. The width of the coating on the web was L2+11 mm with respect to the width L2 (1600 mm) between the side plates regulated by the side plates 5, and it was confirmed that the film could be formed without any problem. In the same manner as in Example 1, even though coating was performed again after the coating liquid continuously flowed at a supply amount of 50 L/min for 3 minutes, a non-coated portion could be formed. The coating liquid supply amount with no bubbles caught on both the upstream side and the downstream side was 10 L/min on the upstream side and 25 L/min on the downstream side.

### Example 4

As illustrated in FIG. 10, the coating bar 1 was supported by rollers (supports 14) intermittently arranged in the web width direction using the fourth coating device 100C. For the coating adjustment width of the partition 2C, holes 8 were intermittently arranged in the web width direction in the partition 2C in a portion where the supports 14 do not exist, and the partition 2C had an inclined surface 6C inclined downward in the vertical direction by 5° from a position below the coating bar 1 in the vertical direction toward the downstream side in the web conveyance direction in a portion where the supports 14 exist. Each of the holes 8 had a diameter of 8 mm, and was formed to communicate with the outside of the partition 2C at a position 10 mm downward in the Z direction. A distance between the centers of the holes in the web width direction was 192 mm. Except for that, coating was performed in the same manner as in Example 1. The results of the coating are shown in Table 1. The width of the coating on the web was L2+8 mm with respect to the width L2 (1600 mm) between the side plates regulated by the side plates 5, and it was confirmed that the film could be formed without any problem. In the same manner as in Example 1, even though coating was performed again after the coating liquid continuously flowed at a supply amount of 50 L/min for 3 minutes, a non-coated width could be formed. The coating liquid supply amount with no bubbles caught on both the upstream side and the downstream side was 10 L/min on the upstream side and 28 L/min on the downstream side.

### Comparative Example 1

Coating was performed under conditions similar to those in Example 1 by a coating device similar to that in Example 1, except that a partition plate having a V-shaped support portion 2a formed across the entire width was used so that V-shaped blocks (without a flow path) having the same cross section were formed outside the side plates. The results of the coating are shown in Table 1. A width of a coating on a web exceeded L2+30 mm with respect to a width L2 (1600 mm) between the side plates regulated by the side plates, and the coating was applied across the entire width of the web. Thereafter, in a transverse stretching process, both end portions of the web in the width direction were gripped with clips, but the clips slipped off, and the web could not be stretched because the coating liquid was interposed between the clips and the web. In the same manner as in Example 1, coating was performed again after the coating liquid continuously flowed at a supply amount of 50 L/min for 3 minutes, but a non-coated portion could not be formed. The coating liquid supply amount with no bubbles caught on both the upstream side and the downstream side was 11 L/min on the upstream side and 25 L/min on the downstream side.

### Comparative Example 2

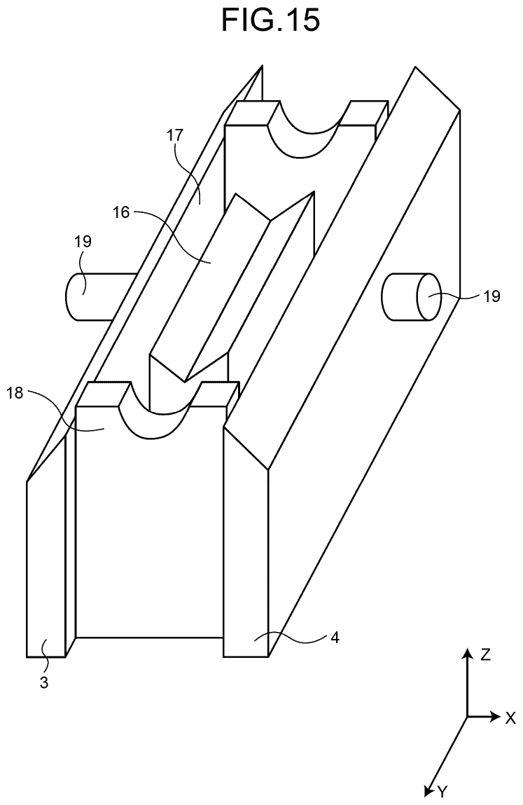

Refer to FIG. 15. FIG. 15 illustrates a coating device described in Patent Literature 4, with a coating bar being removed therefrom. A container 17 is formed by placing side plates 18 at end portions in the web width direction of the coating device. A partition 16 having a V-shaped support portion was applied. The partition 16 has a length of 1250 mm in the web width direction. When the coating width is adjusted to be larger than 1250 mm by sliding the side plates 18 outward in the web width direction, the side plates 18 at the end portions in the web width direction are separated from the partition 16, and the upstream and downstream containers communicate with each other. Coating was performed in the same manner as in Example 1 except that the side plates 18 were separated from the partition 16 by adjusting the coating width to be wide using this coating device. The results of the coating are shown in Table 1. The width of the coating on the web was L2+11 mm with respect to the width L2 (1600 mm) between the side plates regulated by the side plates 18, and it was confirmed that the film could be formed without any problem. In the same manner as in Example 1, even though coating was performed again after the coating liquid continuously flowed at a supply amount of 50 L/min for 3 minutes, a non-coated portion could be formed. The coating liquid supply amount with no bubbles caught on both the upstream side and the downstream side was 20 L/min on the upstream side and 32 L/min on the downstream side. Since the coating liquid freely moved back and forth in the container 17 in which a large amount of coating liquid communicated when the coating bar rotated, it was not possible to control the coating liquid supply amounts on the downstream side and the upstream side, and a large amount of coating liquid was required.

The coating results in Examples and Comparative Examples were evaluated according to the following criteria.

### [Controllability of Coating Width]

It is preferable that the expansion of the coating width is small when compared to the side plate interval L2, and a non-coated portion can be formed when the coating is resumed. Therefore, the preferable criteria for the expansion of the coating width were determined from the coating performance achieved so far by the applicant of the present application, and the controllability of the coating width was evaluated according to the following criteria.
o (Good): The width at which the coating liquid spreads is +30 mm or less when compared to the side plate interval L2, and a non-coated portion can be formed when the coating is resumed.
x (Poor): The width at which the coating liquid spreads more than +30 mm when compared to the side plate interval L2, or a non-coated portion cannot be formed when the coating is resumed.

### [Controllability of Coating Liquid Supply Amount]

In order to prevent bubbles from being caught when coating is performed, it is preferable that the sum of the coating liquid supply amount on the upstream side and the coating liquid supply amount on the downstream side is large. However, this causes a problem that the capacity of the coating liquid supply pump increases and a problem that foreign substances passing through the filter increase. It is preferable that the total coating liquid supply amount is small while preventing bubbles from being caught when coating is performed. Therefore, the controllability of the coating liquid supply amount was evaluated according to the following criteria based on the coating performance achieved so far by the applicant of the present application.
O (Good): The total coating liquid supply amount is 50 L/min or less.
x (Poor): The total coating liquid supply amount exceeds 50 L/min.

### [Overall Evaluation]

The overall evaluation was performed according to the following criteria.
O (Good): Both the controllability of the coating width and the controllability of the coating liquid supply amount are evaluated as O (good).
x (Poor): Either the controllability of the coating width or the controllability of the coating liquid supply amount is evaluated as x (poor).

TABLE 1

| | | | | Controllability of coating liquid | | |
|---|---|---|---|---|---|---|
| | Controllability of coating width | | | supply amount | | |
| | | Whether non- | | Upstream supply | | |
| | Width [mm] | coated portion is | | amount/downstream | | |
| | of coating | formable when | | supply amount (total | | |
| | liquid | coating is | | supply amount in | Evaluation of | |
| | compared to | resumed | Evaluation of | parenthesis) [L/min] | controllability of | |
| | side plate | ∘: Formable | controllability of | when no bubbles are | coating liquid | Overall |
| | interval L2 | x: Not formable | coating width | caught | supply amount | evaluation |
| Example 1 | +8 | ∘ | ∘ | 10/27 (37) | ∘ | ∘ |
| Example 2 | +10 | ∘ | ∘ | 10/25 (35) | ∘ | ∘ |
| Example 3 | +11 | ∘ | ∘ | 10/25 (35) | ∘ | ∘ |
| Example 4 | +8 | ∘ | ∘ | 10/28 (38) | ∘ | ∘ |
| Comparative | More | x | x | 11/25 (36) | ∘ | x |
| example 1 | than +30 | (Coated across | | | | |
| | | entire width) | | | | |
| Comparative | +11 | ∘ | ∘ | 20/32 (52) | x | x |
| example 2 | | | | | | |

### INDUSTRIAL APPLICABILITY

The coating device according to the present invention is applicable when coating liquid is applied onto a web-shaped object such as a film, paper, or a metal foil.

### REFERENCE SIGNS LIST

1 COATING BAR
2 PARTITION
2a SUPPORT PORTION
3 UPSTREAM MAIN PLATE
4 DOWNSTREAM MAIN PLATE
5 SIDE PLATE
6, 6C INCLINED SURFACE
7 GROOVE
8 HOLE
9 WEB
10 UPSTREAM CONTAINER COATING LIQUID SUPPLY PORT
11 DOWNSTREAM CONTAINER COATING LIQUID SUPPLY PORT
12 COATING LIQUID
13 GAP BETWEEN COATING BAR AND PARTITION
14 SUPPORT
15 BUBBLE
16 PARTITION
17 COATING LIQUID SUPPLY TANK
18 MOVABLE SIDE PLATE
19 SUPPLY PORT
20 UPSTREAM CONTAINER
21 DOWNSTREAM CONTAINER
22 SHAFT
L1 WEB WIDTH
L2 WIDTH BETWEEN SIDE PLATES
L3 SUPPORT PORTION WIDTH
100, 100A, 100B, 100C, 100′ COATING DEVICE

1. A coating device for coating a web that is traveling with coating liquid, the coating device comprising:
a coating bar extending in a web width direction;
a partition disposed below an axial center of the coating bar in a vertical direction, the partition extending in the web width direction; and
an upstream container and a downstream container disposed on an upstream side and a downstream side in a web conveyance direction, respectively, with the partition interposed between the upstream container and the downstream container, the upstream container and the downstream container including side plates disposed inward in the web width direction with respect to both ends of the partition on a web width direction side, the upstream container and the downstream container being configured to store the coating liquid,
wherein the partition is a portion that separates the upstream container and the downstream container from each other, and has a flow path for discharging the coating liquid from a position within a range of a web width and outside the side plates in the web width direction.

2. The coating device according to claim 1, wherein the flow path for discharging the coating liquid is a flat surface that is inclined downward in the vertical direction from a position below the coating bar in the vertical direction toward either the upstream side or the downstream side in the web conveyance direction.

3. The coating device according to claim 1, wherein the flow path for discharging the coating liquid is at least one groove having a bottom surface that is inclined downward in the vertical direction from a position below the coating bar in the vertical direction toward either the upstream side or the downstream side in the web conveyance direction.

4. The coating device according to claim 1, wherein the flow path for discharging the coating liquid is at least one hole extending from a position below the coating bar in the vertical direction to a side surface of the partition on either the upstream side or the downstream side in the web conveyance direction through an inside of the partition.

5. The coating device according to claim 1, wherein the side plates are slidable in the web width direction.

6. The coating device according to claim 1, wherein the partition is configured to support the coating bar from below.

7. The coating device according to claim 1, wherein supports configured to support the coating bar from below are spaced apart in the web width direction.

8. A method for producing a web with a coating film by using the coating device according to claim 1, the method comprising coating the web with the coating liquid by pressing the coating bar against the web conveyed from the upstream side to the downstream side at a predetermined speed while supplying the coating liquid to the upstream container and the downstream container.
